(19) United States
(12) Patent Application Publication
(10) Pub. No.: US 2011/0160042 A1
(43) Pub. Date: Jun. 30, 2011

(54) METHOD FOR CONSTRUCTING FRACTAL NETWORK STRUCTURE IN HYDROGEN STORAGE MATERIAL

(75) Inventors: CHENG-SI TSAO, Taoyuan County (TW); Ming-Sheng Yu, Taipei City (TW); Yi-Ren Tzeng, Tainan County (TW); Tsui-Yun Chung, Taipei City (TW); Hsiu-Chu Wu, Pingtung County (TW); Haw-Yeu Chuang, Taoyuan County (TW); Chien-Hung Chen, Taoyuan County (TW); Kang-Ning Lee, Taoyuan County (TW); Hua-Wen Chang, Hsinchu County (TW); Huan-Hsiung Tseng, Miaoli County (TW)

(73) Assignee: Institute of Nuclear Energy Research Atomic Energy Council, Executive Yuan, Taoyuan County (TW)

(21) Appl. No.: 12/905,627

(22) Filed: Oct. 15, 2010

(30) Foreign Application Priority Data
Dec. 28, 2009 (TW) 098145270

(51) Int. Cl. B01J 29/08; B01J 20/00; B01J 35/00; B01J 23/00; B01J 21/18; B01J 21/04; B01J 21/08; B01J 21/16; B01J 29/04; C01B 31/08; B01J 20/08; B01J 20/10; B01J 20/22; B01J 20/26; B82Y 30/00

(52) U.S. Cl. 502/79; 502/400; 502/100; 502/300; 502/180; 502/355; 502/233; 502/80; 502/60; 502/416; 502/415; 502/407; 502/401; 502/402; 977/742

(57) ABSTRACT

The present invention provides a method for constructing a fractal network structure in hydrogen storage material to improve the hydrogen uptake at room temperature, the method including the following steps: providing a hydrogen storage material comprising a source and a receptor of hydrogen atoms, wherein the source is disposed above the receptor, and a chemical bridge is disposed between the source and the receptor, wherein the chemical bridge is composed of precursor material; and treating the hydrogen storage material to construct a fractal network structure of mesopores and micropores in the receptor, so as to enhance the hydrogen storage capacity of the hydrogen storage material at room temperature.

### FIELD OF THE INVENTION

The present invention relates to hydrogen adsorption and storage, and more particularly, to a method for constructing a fractal network structure in hydrogen storage material to enhance its hydrogen uptake capacity.

### TECHNICAL BACKGROUND

Energy resources have getting more and more important for industrialization of a modern nation. After exploitation of petroleum for two centuries, people have been confronting issues of the energy shortage and the environmental climate change. Since the Oil Crisis in 1970s, scientists have endeavored to look for alternative energy to substitute petroleum. Among them, hydrogen, which sources from inexhaustible water, is regarded as one of the promising candidates. Utilizing hydrogen as an energy resource, the final output is only water, and there is no CO₂, the major cause of Global Warming, produced in hydrogen processing. Therefore, hydrogen energy is one of high-efficiency energy resources that meet the requirement of environmental protection, and will become one of main green energy resources in the coming future.

Generally, hydrogen molecules of gaseous state exist in the atmosphere. There are constraints as well as challenges in the field of hydrogen storage and transportation. To accelerate the advent of hydrogen economics, advances in the technology need to be developed. Lightness in density and tendency to explosion has made hydrogen storage more difficult. Hydrogen can be stored in gaseous, liquid, or solid compound state; for example, hydrogen can be compressed so as to be stored in a tank. However, the cost for compression or liquidization of hydrogen is quite large. Moreover, high-pressure storage usually comes along with considerations such as public safety and routine examinations.

Hydrogen can also be stored by liquid state. The atmospheric boiling point of hydrogen molecule is −253° C., so the liquidization process needs compression and cooling, which are usually energy-consuming. Under the condition of such a low temperature, hydrogen storage in the liquid state needs special devices that can operate at a low temperature. Thus, the cost is increased and the exhaustion of vaporized hydrogen needs to be further concerned.

Recently the solid-state storage methods have been proposed to adsorb and thus store hydrogen onto the surface of metal hydride or porous materials, due to the advantages of their safety and convenience. The conventional techniques put emphasis on increasing the specific surface area (SSA) of porous materials to enhance the hydrogen adsorption. On the other hand, the papers “Y. W. Li, R. T. Yang, J. Am. Chem. Soc. 128, 8136 (2006)” and “Y. W. Li, R. T. Yang, J. Phys. Chem. C 111, 11086 (2007)” have proposed applications of porous material doped with transition metal at room temperature. Through the so-called spillover process, the hydrogen storage capacity at the room temperature is enhanced.

The US Department of Energy (DOE) has proposed criteria for hydrogen storage, and some of them are (1) voluminous storage capacity, (2) compact size and light weight, (3) to adsorb and desorb hydrogen at room temperature and moderate pressure. The on-board target criteria of hydrogen storage capacity are 1.5 kw/kg (4.5 wt. %) in 2007, 2 kw/kg (6 wt. %) in 2010, and 3 kw/kg (9 wt. %) in 2015. In order to achieve the targets, intense research energy has been involved to advance the hydrogen storage technology.

At present, nano-structured carbon materials, such as activated carbon, carbon nanotube, graphite nanofiber, and graphite, can be the promising hydrogen adsorbing materials. However, there are still some disadvantages in those materials, such as slow uptake rate and irreversible adsorption. The US patent application publication (Pub. No. 2007/0082816) has disclosed a hydrogen adsorption structure and method, wherein the hydrogen adsorption structure includes a dissociation source and a receptor. A precursor material with a structure of chemical bridge is disposed between the dissociation source and the receptor, so as to induce the spillover phenomenon to cause the dissociated hydrogen atoms adsorbed by the receptor and, hence, to enhance the hydrogen storage capacity.

### SUMMARY OF THE INVENTION

It is one object of the present invention to construct a fractal network structure in hydrogen storage material to improve hydrogen uptake at room temperature. The fractal network structure is composed of pores inside the hydrogen storage material so as to improve the hydrogen storage capacity at room temperature, regardless of the specific surface area (SSA) and the pore volume of the micropores. Thus, a hydrogen storage material without high SSA and pore volume can be possible to achieve high hydrogen storage capacity.

It is another object of the present invention to construct a fractal network structure with mesopores and micropores, and to optimize the regulatory distribution of pore structure, so as to improve the hydrogen storage capacity of a hydrogen storage material. By the spillover effect in the material, the receptor can store more hydrogen atoms at room temperature. The hydrogen adsorption capability can be increased without having a large SSA and a considerable pore volume of the micropores. Therefore, a hydrogen storage material without high SSA and pore volume can be possible to achieve high hydrogen storage capacity.

According to one aspect of the present invention, an embodiment provides a method for constructing a fractal network structure in hydrogen storage material to improve the hydrogen uptake at room temperature, the method comprising the following steps: providing a hydrogen storage material comprising a source and a receptor of hydrogen atoms, wherein the source is disposed above the receptor, and a chemical bridge is disposed between the source and the receptor, wherein the chemical bridge is composed of precursor material; and treating the hydrogen storage material to construct a fractal network structure of mesopores and micropores in the receptor, so as to enhance the hydrogen storage capacity of the hydrogen storage material at room temperature.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram of the flowchart of the method according to an embodiment of the present invention.

FIGS. 2A, 2B and 2C show schematic diagrams of the structure of hydrogen storage materials in the embodiments.

FIG. 3 is the structure of hydrogen storage materials after the pore fractal dimensions are increased according to the embodiment.

FIG. 4 is XRD patterns of M_SC1, M_SC2 and M_SC3, for observing the lattice structure and its defects.

FIG. 5 is SAXS profiles of small angle X-Ray scattering, for comparing the fractal network structure inside the materials.

FIG. 6 is a diagram for comparison of curves of hydrogen uptake capability between the conventional technique and the present embodiment with the fractal network structure.

### DESCRIPTION OF THE EXEMPLARY EMBODIMENTS

For further understanding and recognizing the fulfilled functions and structural characteristics of the disclosure, several exemplary embodiments cooperating with detailed description are presented as the following.

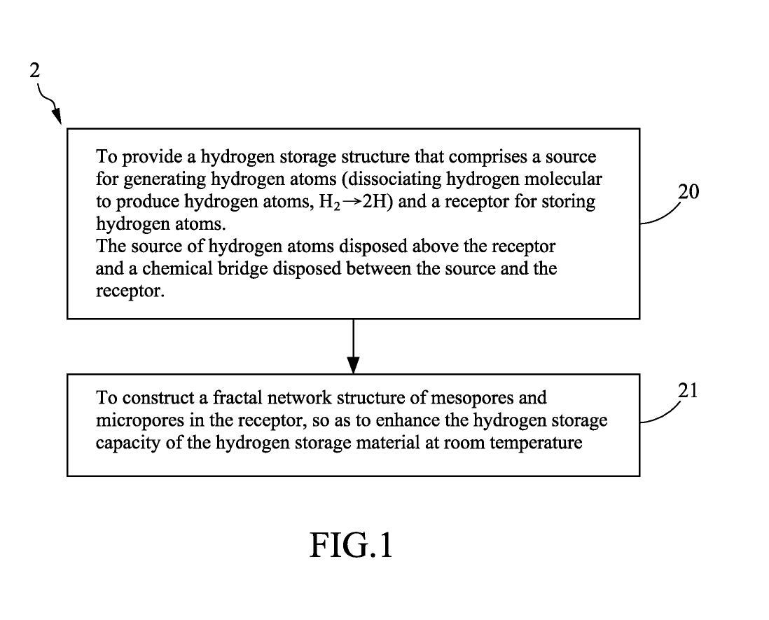

Please refer to FIG. 1, which is a schematic diagram showing the flowchart of a method for constructing a fractal network structure in hydrogen storage material to improve the hydrogen uptake at room temperature, according to an embodiment of the present invention. The method comprises the following steps, wherein step 20 is to provide a hydrogen storage material that includes a source for generating hydrogen atoms (dissociating hydrogen molecular to produce hydrogen atoms, H₂→2H) and a receptor for storing hydrogen atoms, wherein the source is disposed above the receptor, and a chemical bridge is disposed between the source and the receptor, wherein the chemical bridge is composed of precursor material; and step 21 is to treat the hydrogen storage material to construct a fractal network structure of mesopores and micropores in the receptor, so as to enhance the hydrogen storage capacity of the hydrogen storage material at room temperature.

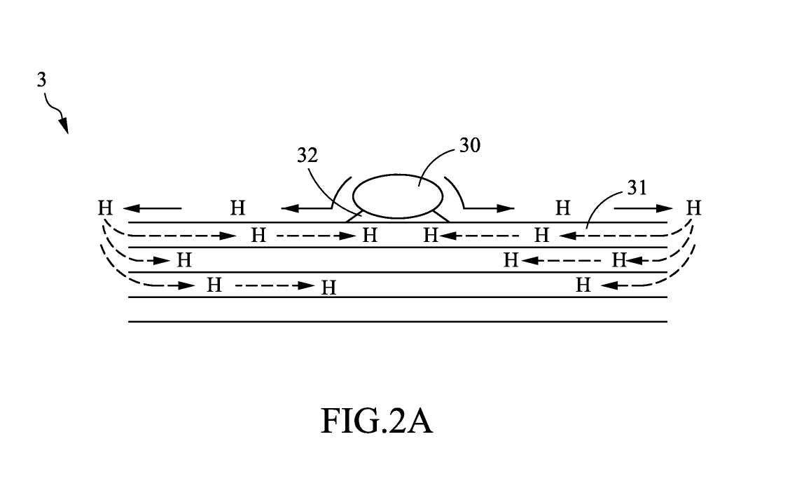

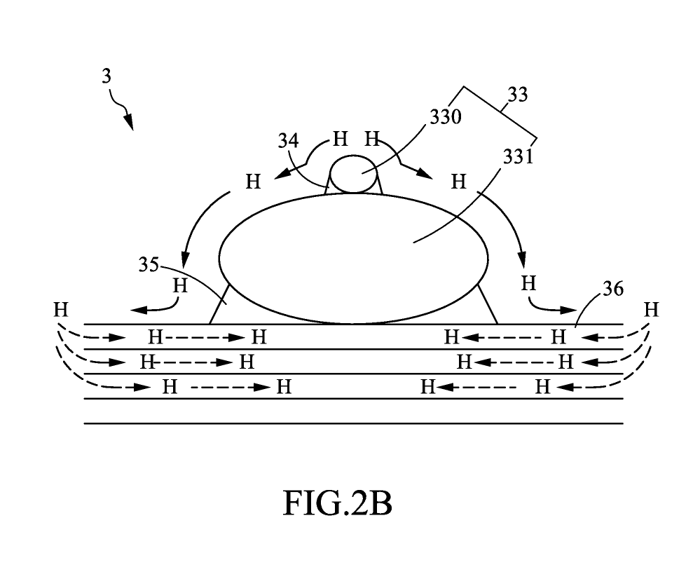

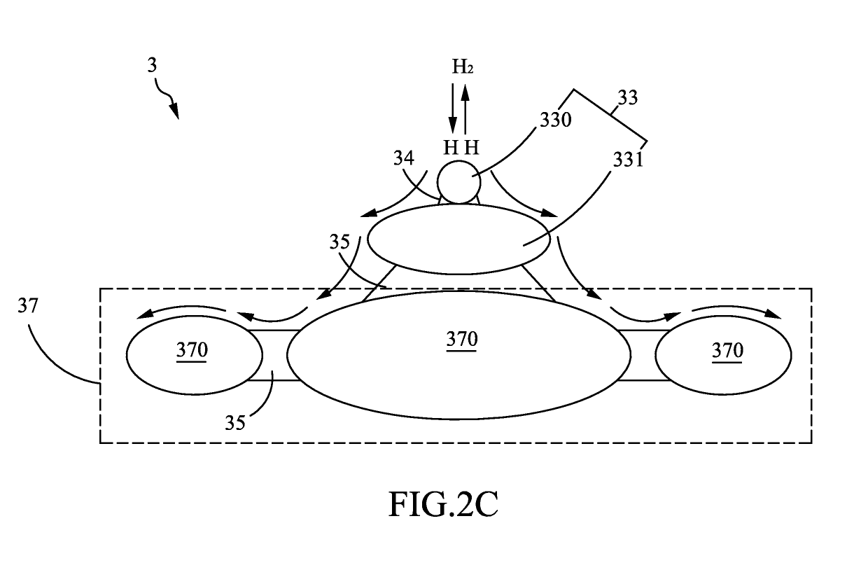

In this embodiment, structure of the hydrogen storage material is schematically shown in FIG. 2A, where the hydrogen storage structure 3 comprises a source 30 and a receptor 31 of hydrogen atoms, and a chemical bridge 32 disposed between the source and the receptor. Preferably, the source for generating hydrogen atoms 30 is a catalyst. The catalyst can be selected from the group consisting of transition metal, noble metal, and hydrogenation catalyst; but is not limited thereby, which can also be one of any combination of the transition metal, noble metal, and hydrogenation catalyst. The receptor 31 can be selected from the group consisting of activated carbon, carbon nanotube, carbon nanofiber, activated alumina, silica gel, clays, metal oxides, molecular sieve, and zeolite; but is not limited thereby, which can also be one of any combination of the activated carbon, carbon nanotube, carbon nanofiber, activated alumina, silica gel, clays, metal oxides, molecular sieve, and zeolite. Moreover, the zeolite can be selected from the group consisting of zeolite X, zeolite Y, zeolite LSX, MCM-41 zeolite, silicoaluminophosphate (SAPO), and the combination thereof.

Further, the receptor of hydrogen atoms storage 31 can be composed of a porous metal-organic framework (MOF), such as MOF-5, IRMOF-8, IRMOF-177, or the combination thereof. In addition to those materials mentioned, the receptor 31 can also be a covalent organic framework (COF), such as COF-1, COF-5, or the combination thereof.

With respect to the chemical bridge 32 in step 20, the structure of the chemical bridge 32 can be selected from the group consisting of carbon bridge, boron bridge, phosphorous bridge, sulfur bridge, and the combination thereof, but is not limited thereby. Further, the chemical bridge is composed of precursor material, which can be selected from the group consisting of sugar, polymer material, surfactant, coal tar, carbon fiber resin, and the combination thereof, but is not limited thereby.

FIG. 2B shows another embodiment of the structure of hydrogen storage materials. In this embodiment, the hydrogen storage structure 3 comprises a source for generating hydrogen atoms 33 and a receptor for storing hydrogen atoms 36, wherein the source of hydrogen atoms 33 includes a catalyst 330 and a support 331. The catalyst 330 has same characteristics as in the previous embodiment of FIG. 2A, and the support 331 can be selected from the group consisting of activated carbon, carbon nanotube, carbon nanofiber, activated alumina, silica gel, clays, metal oxides, molecular sieves, zeolite, and the combination thereof. The structure of the receptor 36 is also the same as in FIG. 2A. There are chemical bridges 34 and 35; one locates between catalyst 330 and support 331, and the other between support 331 and receptor 36. The structure of these chemical bridges are the same as in FIG. 2A. FIG. 2C shows an additional embodiment of the structure of hydrogen storage materials. In this embodiment, the hydrogen storage structure is basically the same as in FIG. 2B, except that the receptor 37 is composed of multiple metal organic frameworks 370 which are connected to each other by the chemical bridges 35.

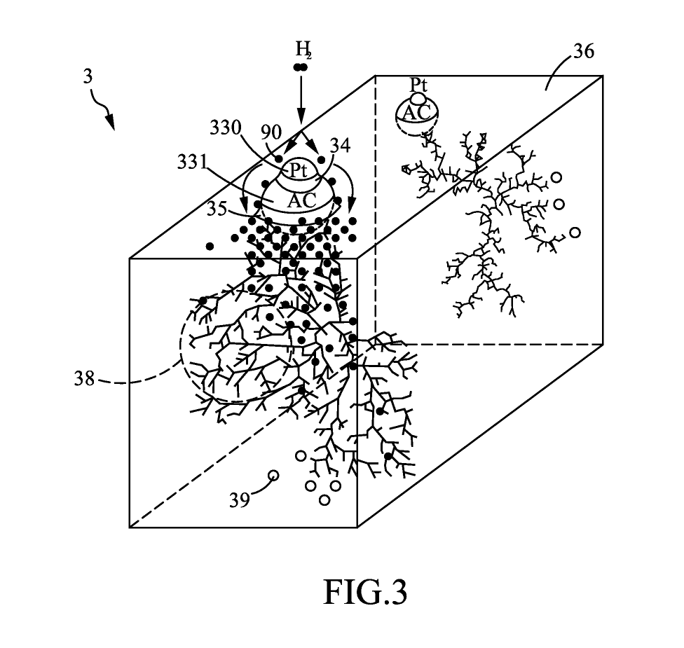

In step 21, by constructing the fractal network structure of the pores in the hydrogen storage receptor and optimizing the distribution of pores structure, the hydrogen storage capacity of the receptor can be effectively enhanced at room temperature. FIG. 3 shows the structure of hydrogen storage materials after the pore fractal dimensions are increased according to the embodiment. As an example of the hydrogen storage structure 3 in FIG. 3, the fractal network structure is formed in the internal pores of the hydrogen storage material by treating the receptor 36 so that mesopores can be formed and distributed as a fractal network structure 38 and, concurrently, micropores 39 can be formed and distributed at surrounding of the fractal network structure 38.

In general, the receptor 36 of hydrogen atoms can be acid-pickling treated to have the oxidizing reaction of the acid solution and the receptor 36 happened, so that the fractal network structure 38 constructed of mesopores and micropores can be formed and distributed. By controlling parameters of the oxidizing reaction, the distribution of mesopores and micropores in the fractal network structure 38 can be further regulated. In addition to the acid pickling treatment and oxidizing reaction, activation treatments of alkaline chemicals (to mix the receptor 36 with alkaline chemicals, such as NaOH and KOH, at a specific ratio, and to thermally treat the mixture to facilitate the receptor 36 to form the fractal network structure 38), physical gas treatment process (to apply high-temperature CO₂ or vapor H₂O to the receptor 36, so that the gasification reaction may facilitate the receptor 36 to form the fractal network structure 38), and some other synthesizing method under specific conditions can also facilitate the receptor 36 to form mesopores and micropores distributed fractal network structure 38.

As shown in FIG. 3, when hydrogen molecules are interacted with Pt 330 (as a catalyst in the embodiment) in the source to generate hydrogen atoms 90. The hydrogen atoms 90 then migrate to AC 331 (activated carbon, as a support in the embodiment) and then diffuse to the receptor 36 to be adsorbed in mesopores and micropores of the fractal network structure. Therefore, the fractal network structure in the receptor 36 can be constructed with mesopores and micropores by effective treatment processes. The distribution of fractal network structure can be optimized by acid pickling treatment, alkaline chemicals activation, physical gas treatment, as well as some other synthesizing method under specific conditions, so that the hydrogen storage capacity of hydrogen storage materials at room temperature can be upgraded, without the need to seek or develop a new material that is of high specific surface area and high pore volume of the micropores. On the other hand, a receptor mainly formed of micropores may have high specific surface area and high pore volume of the micropores, but the micropores can not connect to each other very well, resulting in insufficient specific surface area and, thus, limited hydrogen storage capacity. As to the fractal network structure of the present invention as shown in FIG. 3, however, the pores appear to be distributed, and the mesopores and micropores are well-interconnected. The pores are dependent and coupled well to each other, which can provide a good transporting mechanism for hydrogen atoms and, thus, a high potential of effective hydrogen storage capacity.

In an exemplary embodiment of the present invention IRMOF-8, a conventional material for a receptor 36 of hydrogen atoms, is used to explore the performance of the present invention in comparison to the prior arts. Here provided three IRMOF-8s of different pore structures: M_SC1 (SSA: ˜1500 m²/g), M_SC2 (SSA: ˜1000 m²/g), and M_SC3 (SSA: ˜500 m²/g) with their SSAs in the respective following parentheses.

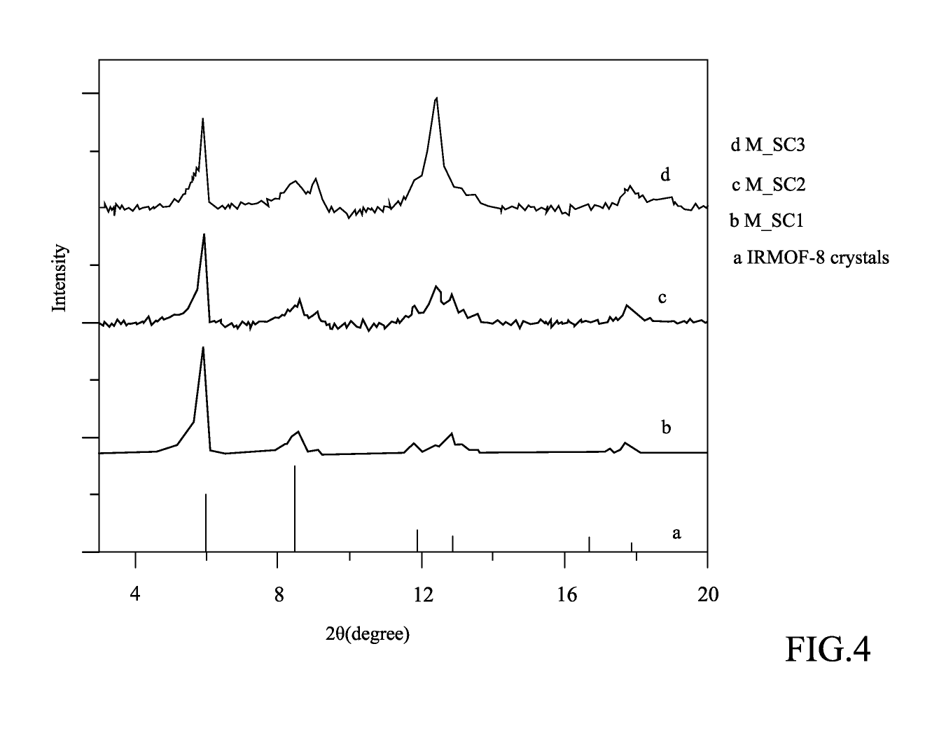

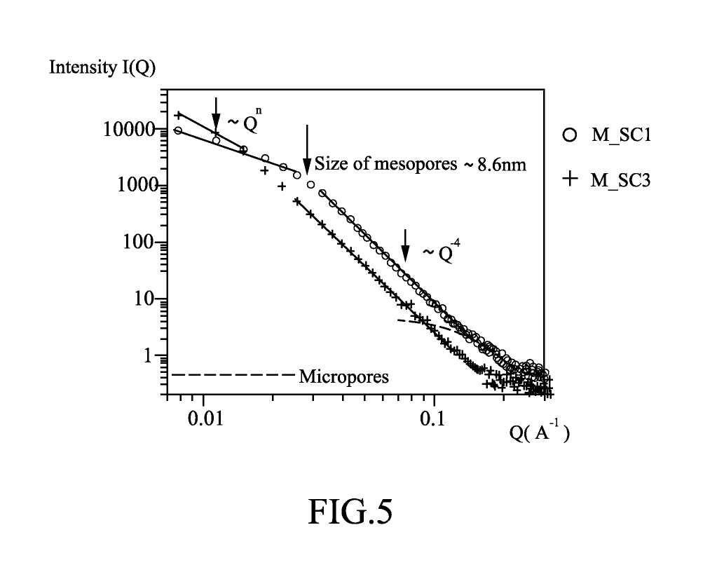

Different treatment processes may result in IRMOF-8s with different defects and SSAs. FIG. 4 is the measured XRD patterns of M_SC1, M_SC2 and M_SC3, showing the peak splitting phenomena and different intensity peaks. Such results can be attributed to the distinct degrees of defect among the material structures. FIG. 5 is the measured profiles of the small-angle X-ray scattering (SAXS) method for each material sample. It can be observed that the fractal network structures appear in all the three IRMOF-8 materials, and the degrees of fractal network structure have a relationship as M_SC3>M_SC2>M_SC1.

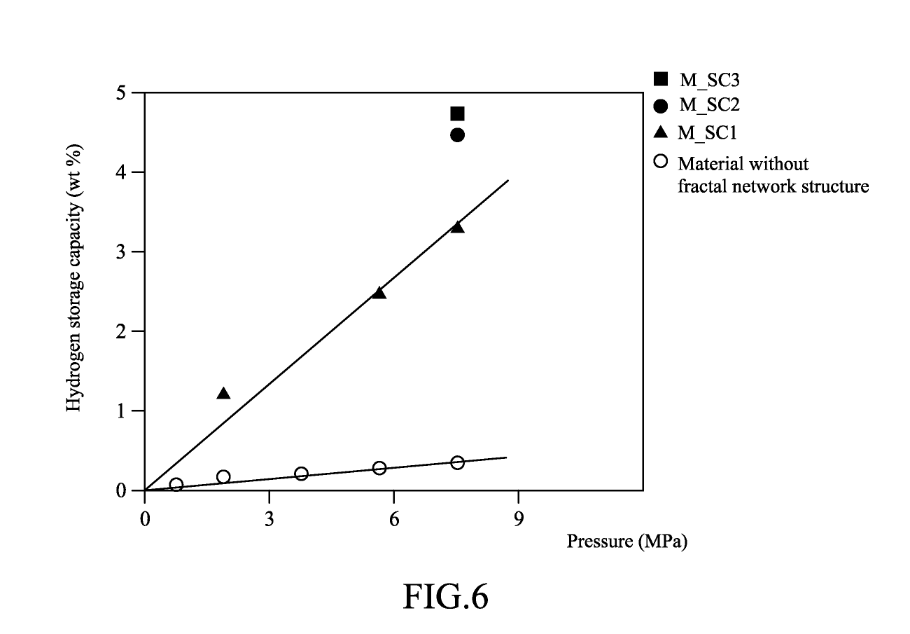

After processed by the method as shown in FIG. 1, the hydrogen storage material can have hydrogen storage capacity of around 5 wt. %. In FIG. 6 it can be obviously observed that the hydrogen adsorption capacity of the material without fractal network structure (denoted as hollow circles) is much less than the other three materials, M_SC1, M_SC2, and M_SC3, with different pore structures according to the present invention. As to conventional hydrogen storage materials, the characteristics of pores are highly related to its hydrogen adsorption behaviors; for example, the more specific surface area and pore volume are, the better hydrogen uptake usually is in the materials. However, the hydrogen storage mechanisms disclosed in the present invention are quite different from the prior arts. The source of hydrogen atoms generates hydrogen atoms via the hydrogen molecule dissociation, and then the hydrogen atoms are spilled over, so that the hydrogen atoms can be adsorbed and thus stored on surface of the receptor. Compared to the high SSA and the high pore volume of the conventional material, the embodiments here is to provide better transportation paths for hydrogen atoms, so that the hydrogen atoms can be migrated or diffused more deeply into the material to be stored there. Although the measured SSA can have the following relation, M_SC1 (SSA: ˜1500 m²/g)>M_SC2 (SSA: ˜1000 m²/g)>M_SC3 (SSA: ˜500 m²/g), the hydrogen adsorption capacities can be observed as M_SC3 (SSA: ˜500 m²/g)>M_SC2 (SSA: ˜1000 m²/g)>M_SC1 (SSA: ˜1500 m²/g) under the same pressure, as shown in FIG. 6. This result demonstrates that the method according to the present invention is capable of enhancing the hydrogen storage capacity only by constructing fractal network structure in the hydrogen storage material, regardless of the SSA and the pore volume of the micropores. Therefore, a hydrogen storage material without high SSA and pore volume can be possible to achieve high hydrogen storage capacity.

With respect to the above description then, it is to be realized that the optimum parametric relationships for the parts of the disclosure, to include variations in size, materials, shape, form, function and manner of operation, assembly and use, are deemed readily apparent and obvious to one skilled in the art, and all equivalent relationships to those illustrated in the figures and described in the specification are intended to be encompassed by the present disclosure.

What is claimed is:

1. A method for constructing a fractal network structure in hydrogen storage material to improve the hydrogen uptake at room temperature, said method comprising the following steps:
providing a hydrogen storage material comprising a source and a receptor of hydrogen atoms, wherein said source is disposed above said receptor, and a chemical bridge is disposed between said source and said receptor, wherein said chemical bridge is composed of precursor material; and
treating said hydrogen storage material to construct a fractal network structure of mesopores and micropores in said receptor, so as to enhance the hydrogen storage capacity of said hydrogen storage material at room temperature.

2. A method as recited in claim 1, wherein said source of hydrogen atoms is a catalyst.

3. A method as recited in claim 2, wherein said catalyst is selected from the group consisting of transition metal, noble metal, hydrogenation catalyst, and the combination thereof.

4. A method as recited in claim 1, wherein said source of hydrogen atoms comprises a catalyst and a support.

5. A method as recited in claim 4, wherein said catalyst is selected from the group consisting of transition metal, noble metal, hydrogenation catalyst, and the combination thereof.

6. A method as recited in claim 4, wherein said support is selected from the group consisting of activated carbon, carbon nanotube, carbon nanofiber, activated alumina, silica gel, clay, metal oxide, molecular sieve, zeolite, and the combination thereof.

7. A method as recited in claim 1, wherein said receptor of hydrogen atoms is selected from the group consisting of activated carbon, carbon nanotube, carbon nanofiber, activated alumina, silica gel, clay, metal oxide, molecular sieve, zeolite, and the combination thereof.

8. A method as recited in claim 7, wherein said zeolite is selected from the group consisting of zeolite X, zeolite Y, zeolite LSX, MCM-41 zeolite, silicoaluminophosphate, and the mixtures thereof.

9. A method as recited in claim 1, wherein said receptor of hydrogen atoms comprises a porous metal organic framework material.

10. A method as recited in claim 9, wherein said metal organic framework material (MOF) is selected from the group consisting of MOF-5, IRMOF-8, IRMOF-177, and the combination thereof.

11. A method as recited in claim 1, wherein said receptor of hydrogen atoms comprises a covalent organic framework (COF).

12. A method as recited in claim 11, wherein said COF is selected from the group consisting of COF-1, COF-5, and the combination thereof.

13. A method as recited in claim 1, wherein said precursor material is selected from the group consisting of sugar, polymer material, surfactant, coal tar, carbon fiber resin, and the combination thereof.

14. A method as recited in claim 1, wherein structure of said chemical bridge is selected from the group consisting of carbon bridge, boron bridge, phosphorous bridge, sulfur bridge, and the combination thereof.

15. A method as recited in claim 1, wherein the step of treating said hydrogen storage material comprises acid pickling and oxidizing reaction process, activation process of alkaline chemicals, or physical gas treatment process, so that the fractal network structure can be constructed in the said receptor.
